(19) United States
(12) Patent Application Publication
(10) Pub. No.: US 2013/0166272 A1
(43) Pub. Date: Jun. 27, 2013

(54) NETWORK PACKET CAPTURE IN EMULATED ENVIRONMENTS

(71) Applicants: Jason Schultz, Plymouth, MN (US); Robert Bergerson, Blaine, MN (US); John Peters, Coon Rapids, MN (US)

(72) Inventors: Jason Schultz, Plymouth, MN (US); Robert Bergerson, Blaine, MN (US); John Peters, Coon Rapids, MN (US)

(21) Appl. No.: 13/334,142

(22) Filed: Dec. 22, 2011

(51) Int. Cl. G06F 9/455

(52) U.S. Cl. 703/23

(57) ABSTRACT

Communications between an application executing in an emulated environment in an operating system and a network stack in the operating system may be improved to allow the application access to additional information. The application may be able to access a network traffic log of the operating system, including contents of packets transmitted and received for the application. The network traffic log may be transmitted to the application by a non-emulated interface executing in the operating system. The application may merge the contents of the network traffic log with an internal application log based on matching similar events between the two logs.

The instant disclosure relates to emulated environments. More specifically, this disclosure relates to logging information within emulated environments.

### BACKGROUND

Applications may be executed in an emulated environment for a number of reasons, such as to provide a sterile sandboxed environment to test an application or to allow an application developed for certain hardware to execute on different hardware. Because the application in the emulated environment does not have information about the operating system and computer system outside of the emulated environment, the application executing in the emulated environment may have limited access to data, including performance data and debug data.

FIG. 1 is a block diagram illustrating a conventional server hosting an emulated environment. An operating system 102 executing on a server 100 includes a networking stack 104. The operating system 102 may be, for example, Linux. An emulated environment 108 in the operating system 102 executes an application 110, such as CPCommOS. The application 110 accesses the networking stack 104 of the operating system 102 through a non-emulated interface 106, such as XNIOP. The non-emulated interface 106 translates requests from the application 110 executing in the emulated environment 108 for the networking stack 104 of the operating system 102.

The application 110 stores a log in a first file 114. The networking stack 104 of the operating system 102 stores a network traffic data log in a second file 112. The second file 112 includes important information for understanding the success or failure of network communications. However, because the application 110 executes in the emulated environment 108, the application 110 does not have access to the data in the second file 112.

### SUMMARY

According to one embodiment, a method includes logging network traffic passed through a networking stack of an operating system. The method also includes logging communications processing in an application executing in an emulated environment in the operating system. The method further includes transmitting the logged network traffic to the application executing in the emulated environment. The method also includes merging the logged network traffic and the logged communications into a combined log accessible by the application executing in the emulated environment in the operating system.

According to another embodiment, a computer program product includes a non-transitory computer readable medium having code to log network traffic passed through a networking stack of an operating system. The medium also includes code to log communications processing in an application executing in an emulated environment in the operating system. The medium further includes code to transmit the logged network traffic to the application executing in the emulated environment. The medium also includes code to merge the logged network traffic and the logged communications into a combined log accessible by the application executing in the emulated environment in the operating system.

According to a further embodiment, an apparatus includes a processor, a network adapter coupled to the processor, and a memory coupled to the processor. The processor is configured to log network traffic passed through the network adapter by logging the network traffic through a networking stack of an operating system. The processor is also configured to log communications processing in an application executing in an emulated environment in the operating system. The processor is further configured to transmit the logged network traffic to the application executing in the emulated environment. The processor is also configured to merge the logged network traffic and the logged communications into a combined log accessible by the application executing in the emulated environment in the operating system.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating conventional logging.

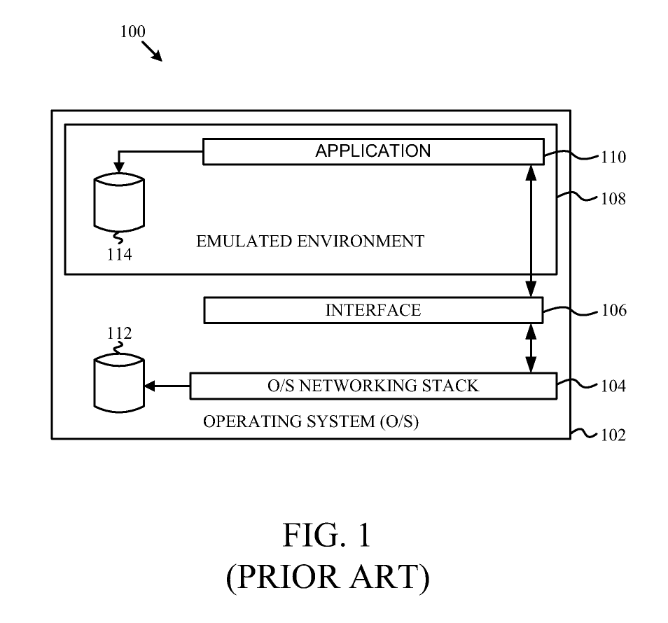

FIG. 2 is a flow chart illustrating an exemplary method for logging data in an emulated environment according to one embodiment of the disclosure.

FIG. 3 is a call diagram illustrating an exemplary method for accessing data logged outside an emulated environment from inside the emulated environment according to one embodiment of the disclosure.

FIG. 4 is a block diagram illustrating an exemplary method of merging log files according to one embodiment of the disclosure.

FIG. 5 is block diagram illustrating a computer network according to one embodiment of the disclosure.

FIG. 6 is a block diagram illustrating a computer system according to one embodiment of the disclosure.

### DETAILED DESCRIPTION

Applications in an emulated environment of an operating system may access data logged outside of the emulated environment through an interface between the emulated environment and the operating system. The application in the emulated environment may log events occurring in the application. The application may also access network traffic logs stored by the operating system through the interface and merge the application log with the network traffic log into a merged file. The merged log file allows the application access to useful data to analyze and debug network traffic.

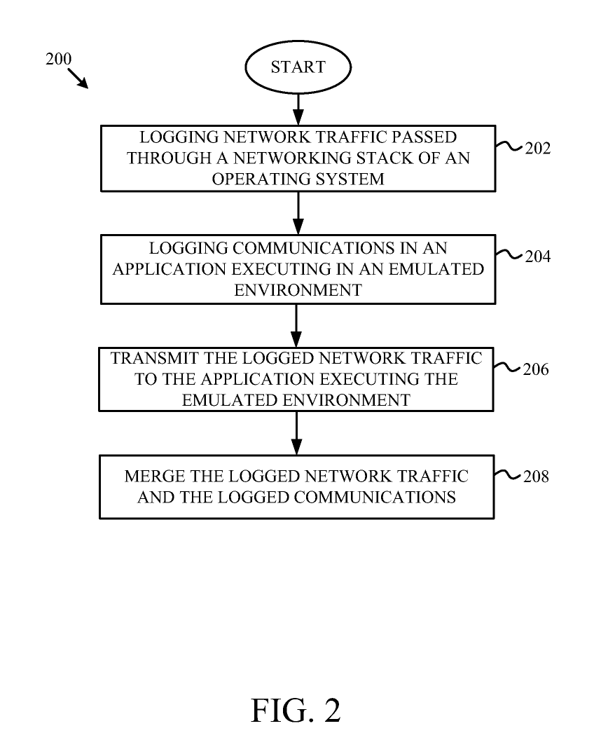

FIG. 2 is a flow chart illustrating an exemplary method for logging data in an emulated environment according to one embodiment of the disclosure. A method 200 begins at block 202 with logging network traffic passed through a networking stack of an operating system in a first file. The network traffic may be captured by, for example, a network capture library when the operating system is Linux. The network capture library may cooperate with a transmission control protocol/internet protocol (TCP/IP) stack to capture packets and store the packets, or portions of the packets, in the first file. The first file may be stored in a storage device attached to or connected to the computer system running the operating system.

At block 204, communications are logged in a second file by an application executing in an emulated environment. At block 206, the logged network traffic by the operating system is transmitted to the application executing in the emulated environment. The logged network traffic may be transmitted through an interface between the emulated environment and the operating system. The interface may use a tcpdump utility or a pcap library in the operating system to retrieve the network traffic logs before transmitting the logs to the application. At block 208, the logged network traffic and the logged communications may be merged into a single combined log file.

According to one embodiment, networking traffic may also be logged at an interface between the networking stack and the application executing in the emulated environment. Thus, the logged network traffic transferred at block 206 may also include the interface log. Further, the log merging at block 208 may include the network traffic log, the logged communications in the application, and the interface log.

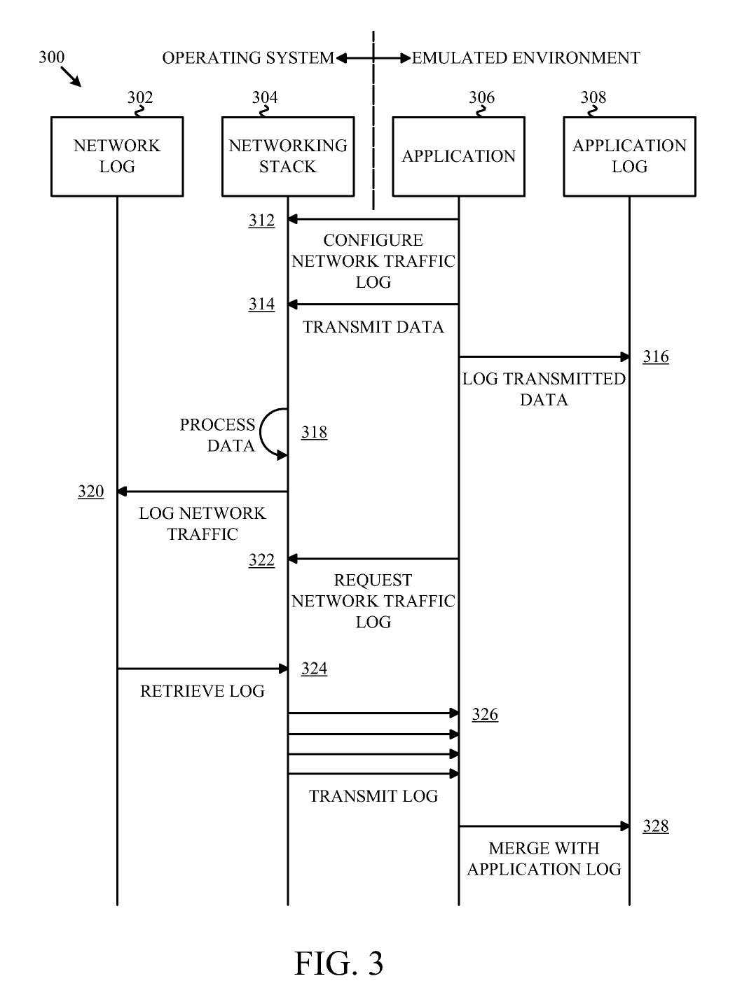

FIG. 3 is a call diagram illustrating an exemplary method for accessing data logged outside an emulated environment from inside the emulated environment according to one embodiment of the disclosure. A call flow 300 includes a network log 302 and a networking stack 304 in an operating system. The call diagram 300 also includes an application 306 and an application log 308 in an emulated environment.

Communications between the application 306 and the networking stack 304 may begin with the application 306 signaling the networking stack 304 with a configuration for logging network traffic at call 312. According to one embodiment, the communications described between the application 306 and the networking stack 304 occur through a non-emulated interface. The configuration information may include an identification of which network packets to log and when to log the network packets. For example, the configuration information may include filters for specifying which packets to log according to network protocol, network port, network interface name, file size, number of capture files, source address, and/or destination address. The filter information may be provided to the networking stack, for example, as a regular expression or a Boolean expression. In another example, the configuration information may include filters specifying times for logging data, such as when a debug flag is set in the application 306. The networking stack 304 may return an error to the application 306 if the configuration information is incorrect. According to one embodiment, the networking stack 304 may transmit unsolicited information to the application 306, such as a notification that the log files are full.

The call flow 300 continues with the application 306 transmitting data, for transmission over a network interface, to the networking stack 304 at call 314. Although the networking stack 304 is illustrated, the interface between the networking stack 304 and the application 306 may log the network traffic as described below. The data may be logged by the application 306 in the application log 308 at call 316. At call 318, the data is received by the networking stack 304 and transmitted through a network interface. The networking stack 304 writes network traffic information to the network log 302 at call 320, when the data matches filters configured at call 312. For example, when the application 306 instructs the networking stack 304 to log simple mail transfer protocol (SMTP) packets, the SMTP packets are logged at call 320.

Calls 314, 316, 318, and 320 may be repeated many times as the application 306 continues to transmit data through network interfaces available to the operating system. The data transmitted by the application 306 at call 314 may include a number of different types of network data, of which some, none, or all may match the filters configured at call 312. After some time the application 306 may request information regarding the status of the data transmissions. For example, if network communications fail repeatedly, the application 306 may enter into a debugging mode and begin to analyze information in the application log 308. The application 306 may benefit from network log information stored by the operating system in the network log 302.

At call 322, the application 306 may request the network traffic log 302 from the networking stack 304. The networking stack 304 may retrieve the log at call 324 and transmit the log to the application 306 at call 326. According to one embodiment, the network traffic log 302 may be transmitted to the application 306 as a complete file. According to another embodiment, the network traffic log 302 may be divided into a plurality of packets that are transmitted sequentially to the application 306.

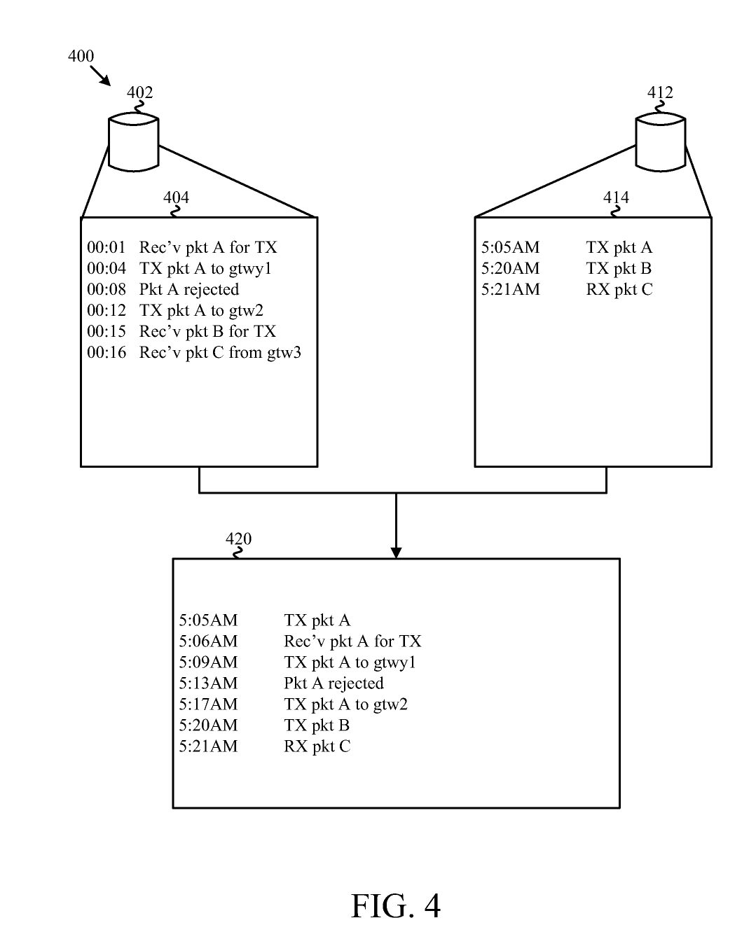

At call 328, the application 306 may merge the network log 302 received from the networking stack 304 with the application log 308. FIG. 4 is a block diagram illustrating an exemplary method of merging log files according to one embodiment of the disclosure. A first file 402 may include a network traffic log 404, and a second file 412 may include an application log 414. The network traffic log 404 may be merged with the application log 414 to create a combined log 420. The files 402 and 412 may include different formatting, such as when one file is tab-delimited text and the other file is comma-delimited text. Additionally, the files 402 and 412 may include different output format, such as when one file uses a 24-hour clock and another file uses a 12-hour clock. Further, the files 402 and 412 may have events recorded on non-synchronous clocks. That is, the recorded times for the first file 402 may not directly correspond to the second file 412. When merging the network traffic log 404 with the application log 414, the data may be formatted into a uniform format. For example, the combined log 420 may convert the time stamps in the network traffic log 404 into the format of the time stamps of the application log 414.

When the clocks for the files 402 and 412 are not synchronous, the merging may be performed by identifying similar events in the logs. For example, the event in the network traffic log 404 identifying “Rec'v pkt A for TX” (receive packet A for transmission) may be matched with the event in the application log 414 identifying “TX pkt A.” Similarly, the event in the network traffic log 404 identifying “Rec'v pkt B for TX” (receive packet B for transmission) may be matched with the event in the application log 414 identifying “TX pkt B.” The events occurring between the matched events may be inserted in the combined log 420 between the matched events.

The merging of data files described above in FIG. 4 may be adapted to include additional log files. For example, in addition to merging the network traffic log from the networking stack and the communications log from the application, network traffic logged at the interface between the application and the networking stack may be merged into the single log file.

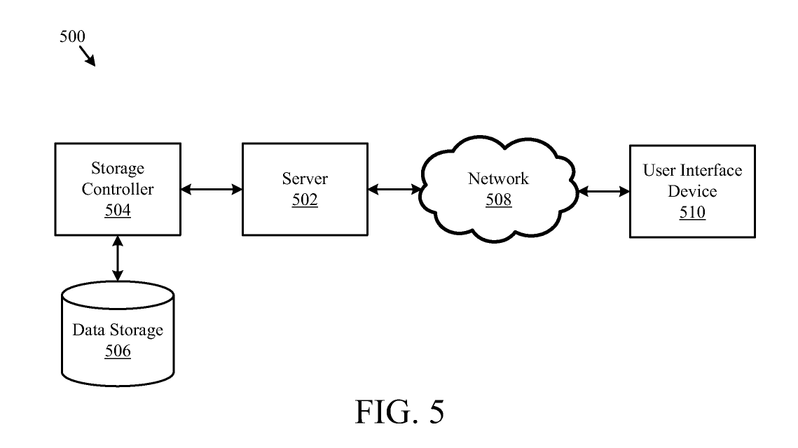

FIG. 5 illustrates one embodiment of a system 500 for an information system, such as a system for executing programs in an emulated environment. The system 500 may include a server 502, a data storage device 506, a network 508, and a user interface device 510. The server 502 may be a dedicated server or one server in a cloud computing system. In a further embodiment, the system 500 may include a storage controller 504, or storage server configured to manage data communications between the data storage device 506 and the server 502 or other components in communication with the network 508. In an alternative embodiment, the storage controller 504 may be coupled to the network 508.

In one embodiment, the user interface device 510 is referred to broadly and is intended to encompass a suitable processor-based device such as a desktop computer, a laptop computer, a personal digital assistant (PDA) or tablet computer, a smartphone or other a mobile communication device having access to the network 508. When the device 510 is a mobile device, sensors (not shown), such as a camera or accelerometer, may be embedded in the device 510. When the device 510 is a desktop computer the sensors may be embedded in an attachment (not shown) to the device 510. In a further embodiment, the user interface device 510 may access the Internet or other wide area or local area network to access a web application or web service hosted by the server 502 and provide a user interface for enabling a user to enter or receive information.

The network 508 may facilitate communications of data, such as authentication information, between the server 502 and the user interface device 510. The network 508 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the user interface device 510 accesses the server 502 through an intermediate sever (not shown). For example, in a cloud application the user interface device 510 may access an application server. The application server fulfills requests from the user interface device 510 by accessing a database management system (DBMS). In this embodiment, the user interface device 510 may be a computer or phone executing a Java application making requests to a JBOSS server executing on a Linux server, which fulfills the requests by accessing a relational database management system (RDMS) on a mainframe server.

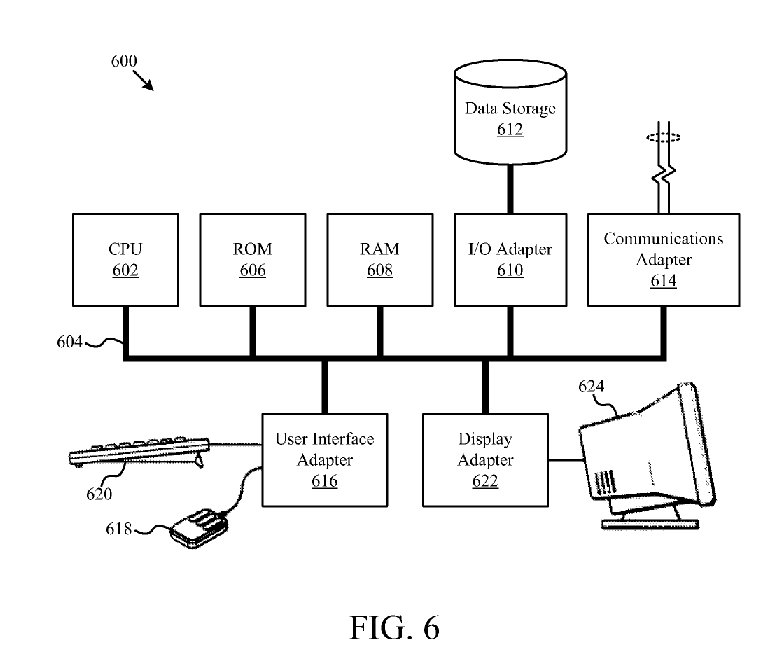

FIG. 6 illustrates a computer system 600 adapted according to certain embodiments of the server 502 and/or the user interface device 510. The central processing unit (“CPU”) 602 is coupled to the system bus 604. The CPU 602 may be a general purpose CPU or microprocessor, graphics processing unit (“GPU”), and/or microcontroller. The present embodiments are not restricted by the architecture of the CPU 602 so long as the CPU 602, whether directly or indirectly, supports the modules and operations as described herein. The CPU 602 may execute the various logical instructions according to the present embodiments.

The computer system 600 also may include random access memory (RAM) 608, which may be synchronous RAM (SRAM), dynamic RAM (DRAM), and/or synchronous dynamic RAM (SDRAM). The computer system 600 may utilize RAM 608 to store the various data structures used by a software application. The computer system 600 may also include read only memory (ROM) 606 which may be PROM, EPROM, EEPROM, optical storage, or the like. The ROM may store configuration information for booting the computer system 600. The RAM 608 and the ROM 606 hold user and system data.

The computer system 600 may also include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a flash drive, a compact disc (CD) drive, a floppy disk drive, and a tape drive, to the computer system 600. The communications adapter 614 may be adapted to couple the computer system 600 to the network 508, which may be one or more of a LAN, WAN, and/or the Internet. The communications adapter 614 may also be adapted to couple the computer system 600 to other networks such as a global positioning system (GPS) or a Bluetooth network. The user interface adapter 616 couples user input devices, such as a keyboard 620, a pointing device 618, and/or a touch screen (not shown) to the computer system 600. The keyboard 620 may be an on-screen keyboard displayed on a touch panel. Additional devices (not shown) such as a camera, microphone, video camera, accelerometer, compass, and or a gyroscope may be coupled to the user interface adapter 616. The display adapter 622 may be driven by the CPU 602 to control the display on the display device 624.

The applications of the present disclosure are not limited to the architecture of computer system 600. Rather the computer system 600 is provided as an example of one type of computing device that may be adapted to perform the functions of a server 502 and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
logging network traffic passed through a networking stack of an operating system;
logging communications in an application executing in an emulated environment in the operating system;
transmitting the logged network traffic to the application executing in the emulated environment; and
merging the logged network traffic and the logged communications into a combined log accessible by the application executing in the emulated environment in the operating system.

2. The method of claim 1, further comprising storing the contents of packets of the network traffic passed through the networking stack.

3. The method of claim 1, further comprising:
storing the logged network traffic in a first file; and
storing the logged application communication in a second file,
in which the step of merging the logged network traffic and the logged communications comprises merging the first file and the second file.

4. The method of claim 3, further comprising transmitting the second file to the application in the emulated environment through a plurality of messages.

5. The method of claim 3, further comprising sorting the combined log in chronological order.

6. The method of claim 4, further comprising adjusting the chronological timeline of at least one of the first file and the second file such that the first file and the second file have a common clock.

7. The method of claim 1, in which logging network traffic comprises logging at least one of protocol, port, source address, and destination address.

8. The method of claim 1, further comprising receiving, at the operating system, an instruction from the application in the emulated environment specifying a configuration for logging the network traffic.

9. A computer program product, comprising:
a non-transitory computer readable medium comprising:
code to log network traffic passed through a networking stack of an operating system;
code to log communications in an application executing in an emulated environment in the operating system;
code to transmit the logged network traffic to the application executing in the emulated environment; and
code to merge the logged network traffic and the logged communications into a combined log accessible by the application executing in the emulated environment in the operating system.

10. The computer program product of claim 9, in which the medium further comprises code to store the contents of packets of the network traffic passed through the networking stack.

11. The computer program product of claim 9, in which the medium further comprises:
code to store the logged network traffic in a first file; and
code to store the logged application communication in a second file,
in which the code to merge the logged network traffic and the logged communications comprises code to merge the first file and the second file.

12. The computer program product of claim 11, in which the medium further comprises code to transmit the second file to the application in the emulated environment through a plurality of messages.

13. The computer program product of claim 11, in which the medium further comprises code to sort the combined log in chronological order.

14. The computer program product of claim 13, in which the medium further comprises code to adjust the chronological timeline of at least one of the first file and the second file such that the first file and the second file have a common clock.

15. The computer program product of claim 9, in which the medium further comprises code to receive, at the operating system, an instruction from the application in the emulated environment specifying a configuration for logging the network traffic.

16. An apparatus, comprising:
a processor;
a network adapter coupled to the processor; and
a memory coupled to the processor, in which the processor is configured:
to log network traffic passed through the network adapter by logging the network traffic through a networking stack of an operating system;
to log communications in an application executing in an emulated environment in the operating system;
to transmit the logged network traffic to the application executing in the emulated environment; and
to merge the logged network traffic and the logged communications into a combined log accessible by the application executing in the emulated environment in the operating system.

17. The apparatus of claim 16, in which the processor is further configured to store the contents of packets of the network traffic passed through the networking stack.

18. The apparatus of claim 16, in which the processor is further configured:
to store the logged network traffic in a first file in the memory; and
to store the logged application communication in a second file in the memory,
in which the step of merging the logged network traffic and the logged communications comprises merging the first file and the second file.

19. The apparatus of claim 18, in which the processor is further configured to adjust the chronological timeline of at least one of the first file and the second file such that the first file and the second file have a common clock.

20. The apparatus of claim 16, in which the processor is further configured to receive, at the operating system, an instruction from the application in the emulated environment specifying a configuration for logging the network traffic.
